(19) United States
(12) Patent Application Publication
(10) Pub. No.: US 2021/0016536 A1
(43) Pub. Date: Jan. 21, 2021

(54) METHOD FOR IMPROVING DRYNESS OF INSULATION MATERIAL AND ARTICLES COMPRISING IMPROVED INSULATION MATERIALS

(71) Applicant: CONSULTATION HANCO CORP, Laval (CA)

(72) Inventor: Sae Heung CHANG, Laval (CA)

(21) Appl. No.: 16/979,770

(22) PCT Filed: Mar. 12, 2019
(86) PCT No.: PCT/CA2019/050305

§ 371 Date: Sep. 10, 2020

Related U.S. Application Data
(60) Provisional application No. 62/641,619, filed on Mar. 12, 2018.
(60) Provisional application No. 62/645,961, filed on Mar. 21, 2018.

(51) Int. Cl. B32B 3/06; A41D 31/06; A41D 31/12; A41D 27/02; D06M 17/00; B32B 27/12; B32B 5/02; B32B 7/05; B32B 27/20; B32B 27/14; B32B 5/16

(52) U.S. Cl. CPC B32B 3/06; B82Y 30/00; A41D 31/125; A41D 27/02; D06M 17/00; B32B 27/12; B32B 5/022; B32B 5/024; B32B 7/05; B32B 27/20; B32B 27/14; B32B 5/16; B32B 2307/724; B32B 2307/7145; B32B 2307/726; A41D 31/065

(57) ABSTRACT

The present technology generally relates to an encasing for receiving a down material, the encasing being formed by a first layer of material and a second layer of material joined together along their periphery; wherein the first layer of material comprises a non-woven material; the encasing further comprising a first layer of shell material apposed onto an exterior side of the first layer of material; wherein the second layer of material is a second layer of non-woven material or a second layer of shell material; and wherein the second layer of material is a second layer of non-woven material, a second layer of shell material is apposed onto an exterior side of the second layer of non-woven material.

### CROSS-REFERENCE TO RELATED APPLICATIONS

The present application is related to and claims priority to U.S. Provisional Patent Application No. 62/641,619 filed Mar. 12, 2018, and to U.S. Provisional Patent Application No. 62/645,961 filed Mar. 21, 2018 which are both incorporated by reference herein in their entirety.

### TECHNICAL FIELD

The present technology generally relates to a method for improving dryness of down feather material and/or any other natural fibers in articles of manufacture comprising the insulation material obtained by the methods of the present technology. The present technology also generally relates to insulation material obtained by the methods of the present technology, which provides the performance benefits described herein.

### BACKGROUND INFORMATION

Feather down, also referred to as “down feather” or simply “down” in more general terms, is used extensively in home-fashion products, apparel, sleeping bags, etc. Down feather is generally obtained from ducks and geese and high quality of down material is known as the warmest and most efficient insulation material based on a unit weight. When used herein, the terms “feather down”, “feather down material”, “down feather”, “down feather material” or “down” means natural down material harvested from ducks and geese as well as man-made fibers which exhibit similar characteristics of natural down, known as synthetic down. This invention also includes other types of natural fibers such as wool, cotton, linen, silk, etc., which has such properties as moisture absorption, leak towards exterior of the articles designed and manufactured to contain them. Feather down articles are typically manufactured using an outer casement or covering (commonly known as the “shell”, “tick” or “down bag”) which holds the feather down within its confines. While a variety of fabrics may be used for the outer material, cotton, polyester, nylon are typically used because of its ability to easily wick moisture. Shells can be made from using numerous fibers (cotton, rayon, silk) and weaves (Jacquard, Dobby, Damask, Sateen, Twill).

Feather down offers excellent thermal properties, and has good lofting characteristics. This means that the feather down traps small pockets of air efficiently. The small pockets of air provide a thermal barrier against cold air as they capture body heat and keep it. Feather down also has the added property that it can be packed into a very small space. For example, down filled pillows have long been known for both their softness and their ability to conform to shapes desired by the user. In addition, down may be used as insulation in garments and other items to keep the user warm in cold environments.

Fillers such as down may be used. Moisture may reduce the efficiency of the down to retain warm air in the air pockets. Moisture may be introduced via sweat from the user, condensation, or from the ambient environment. Chemicals may be used to minimize moisture effects however this is not desirable since manufacturing of the chemicals leaves an environmental footprint. Further, the chemicals may be negated after a few wash cycles.

Japanese Pat. No. 10266053 relates to nonwoven fabric interlocked with feather fiber, its production and heat-insulation material and moisture-controlling material produced by using the nonwoven fabric. The described nonwoven fabric interlocked with feather fiber includes a wet-process nonwoven fabric having excellent heat-retaining property and heat-insulation property. A nonwoven fabric interlocked with feather fiber is produced by ejecting high-pressure water jet against a sheet produced by the wet sheet-making process of feather fiber and a fiber composition such as pulp fiber, thereby entangling the fibers of the fiber composition and the feather fiber. This water-jet entangled nonwoven fabric is suitable for heat-retention use because the feather fiber entangled with the pulp fiber, etc., almost completely holds the characteristic properties of the feather fiber such as heat-retaining property and heat-insulation property. Further, the process has excellent productivity and a wet-process nonwoven fabric can be produced at a low cost by the adoption of the water-jet entangling process.

To remove moisture from articles containing down material such as down garments, pillows, sleeping bags, etc., the articles may be air-dried over a very long period of time or dried by a machine through many repeated cycles, due to its inability to efficiently remove water/moisture under the methods of manufacturing the articles before this invention.

Down can make its way out from the encasing fabrics such as shell, lining fabric, down bag, etc., due to the gap between the crossing points of warp and weft yarns consisting of general construction of fabrics. The above phenomenon is generally known as “down-leak”. Currently, consumer goods containing down as filler use various ways to prevent down leak. One of the most typical and widely used solutions of such is to coat the shell fabrics with chemicals such as waterproofing material, etc. However, although this type of chemical treatment may help prevent down-leak in the crossing points of warp and weft yarns, it cannot prevent the leak from the needle holes, which leaves a gap between the sewing thread and the adjacent fabric for down material to escape.

Waterproofing material mentioned above may contribute to reduce the down-leak, but it creates a significant side effect of delaying the moisture escape from down material in drying process after wash or sweat from human body. When washed and dried, apparel or home fashion products, e.g., pillows, comforters, etc., containing down material as filler, it can take many drying cycles to completely dry because the waterproofing treatment slows down the drying process. Many people resort to taking their down-filled apparel and/or home fashion products to local dry-cleaning shops because of the above issue.

However, resorting to dry-cleaning invariably leads to higher costs as well as environmental footprint because a large quantity of drying cleaning chemicals used today is harmful not only for environment but also for human health.

Issues mentioned above may lead to people using down-filled-products only partially dried. The inadequate drying may lead to bacterial growth. As down material is animal by-product and our human body produces food for bacteria through sweat such as fatty acid, urea, ammonia, etc., wet down can provide a fertile ground for bacterial growth. The bacterial growth leaves unpleasant odor on the articles containing down material. Molds may also grow in the articles which is hazardous to the health of the user-wearer. A suitable solution is desired.

### SUMMARY OF DISCLOSURE

According to various aspects, the present technology generally relates to an encasing for receiving a down material, the encasing being formed by a first layer of material and a second layer of material joined together along their periphery to define an interior environment to accept the down-material; wherein the first layer of material comprises a non-woven material; the encasing further comprising a first layer of shell material apposed onto an exterior side of the first layer of material; wherein the second layer of material is a second layer of non-woven material or is a second layer of shell material; and wherein the second layer of material is the second layer of non-woven material, a second layer of shell material is apposed onto an exterior side of the second layer of non-woven material.

According to various aspects, the present technology generally relates to an object comprising the encasing as defined herein.

According to various aspects, the present technology generally relates to a method of improving down-proof to down insulation, the method comprising: forming an encasing as defined herein; inserting a down material into the encasing; and closing the encasing to encapsulate the down-material.

According to various aspects, the present technology generally relates to a method of improving down-proof to down insulation, the method comprising: covering a down material with at least a first layer of non-woven material on a first-side of the down material, said non-woven material being suitable to prevent down leak with a minimum treatment of waterproof chemicals and/or completely removing the chemical use; and covering the down material with a second layer of material on a second-side of the down material; covering the first layer of non-woven material with a first layer of shell material; and covering the second layer of non-woven material with a second layer of shell material.

According to various aspects, the present technology generally relates to a method of improving dryness to down insulation, the method comprising: forming an encasing as defined herein; inserting a down material into the encasing; and closing the encasing to encapsulate the down-material.

According to various aspects, the present technology generally relates to a method of improving dryness to down insulation, the method comprising: covering a down material with at least a first layer of non-woven material on a first-side of the down material, said non-woven material being suitable to allow moisture extraction out of the down material without condensation; and covering the down material with a second layer of material on a second-side of the down material; covering the first layer of non-woven material with a first layer of shell material; and covering the second layer of non-woven material with a second layer of shell material.

### BRIEF DESCRIPTION OF THE DRAWINGS

Further aspects and advantages of the present technology will become better understood with reference to the description in association with the following in which:

FIGS. 1A-1B-1C are perspective views of a down-filled object according to an embodiment of the present disclosure, wherein the down-filled object comprises four layers of materials; FIG. 1A shows an exploded view of the down-filled object, wherein the various layers of the object are disassembled; FIG. 1B shows an exploded view of the down-filled object, wherein the various layers of the object are arranged in layers; and FIG. 1B and FIB. 1C show two different views of the down-filled object, wherein the various layers of the object are have been assembled.

FIGS. 2A-2B is a perspective view of a down-filled object according to an embodiment of the present disclosure, wherein the down-filled object comprises three layers of materials; FIG. 2A shows an exploded view of the down-filled object, wherein the various layers of the object are disassembled; and

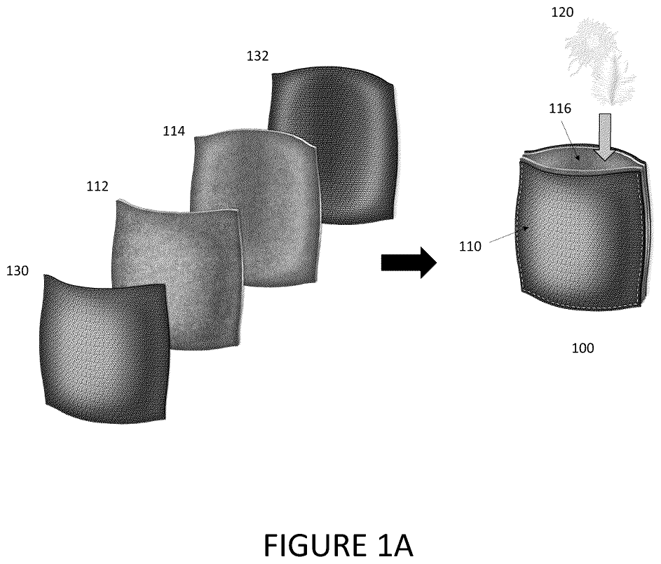

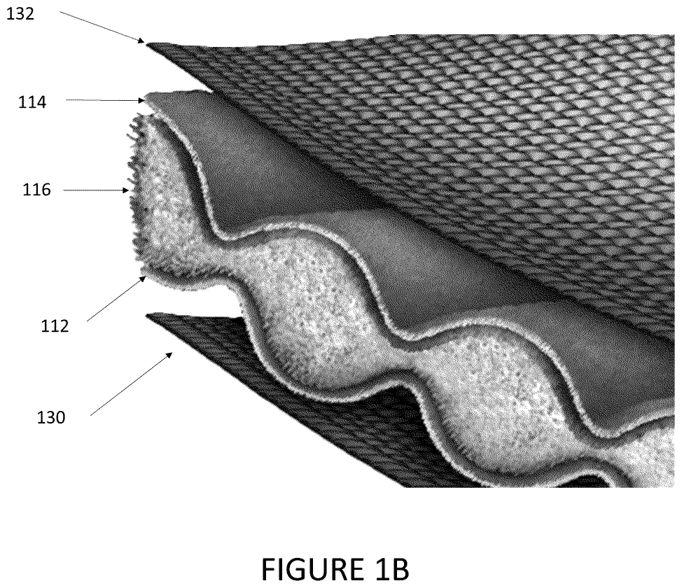

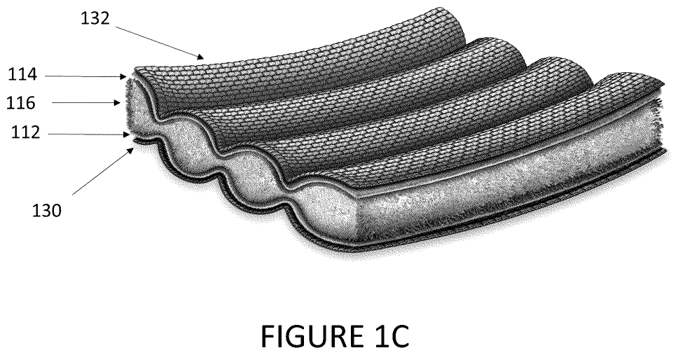

FIG. 1B shows a view of the down-filled object, wherein the various layers of the object are have been assembled.

FIGS. 3A-3B is a further perspective view of a down-filled object according to an embodiment of the present disclosure, wherein the down-filled object comprises three layers of materials;

FIG. 3A shows an exploded view of the down-filled object, wherein the various layers of the object are disassembled; and FIG. 3B shows a view of the down-filled object, wherein the various layers of the object are have been assembled.

FIG. 4 is a graph showing the water quantity retention in a down-filled object according to one embodiment of the present technology;

FIGS. 5A, 5B and 5C are graphs showing volume recovery potential of a down-filled object according to the present technology; FIG. 5A: volume recovery % by time; FIG. 5B: volume per residual water weight ratio; and FIG. 5C: volume per jacket weight ratio; and

FIGS. 6A and 6B are graphs showing the thermal efficiency, drying time and volume increase of a down-filled object according to the present technology based on ASTM D1518; A: CLO test results—stationary hot plate test; B: Drying time (hr)—stationary hot plate test.

The various embodiments of the present technology will hereinafter be described in conjunction with the appended drawings, wherein like designations denote like elements.

### DETAILED DESCRIPTION

The present technology is explained in greater detail below. This description is not intended to be a detailed catalog of all the different ways in which the technology may be implemented, or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art in light of the instant disclosure which do not depart from the instant technology. Hence, the following specification is intended to illustrate some particular embodiments of the technology, and not to exhaustively specify all permutations, combinations and variations thereof.

As used herein, the singular form “a”, “an” and “the” include plural referents unless the context clearly dictates otherwise.

The term “about” is used herein explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value.

The expression “and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

It will be understood that when an element is referred to as being “on” another element, it can be directly on the other element or intervening elements may be present therebetween.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

Relative terms, such as “lower” or “bottom”, “upper” or “top”, “left” or “right”, “above” or “below”, “front” or “rear” may be used herein to describe one element's relationship to another element as illustrated in the Figures. It will be understood that relative terms are intended to encompass different orientations of the device in addition to the orientation depicted in the Figures.

In one embodiment, the present disclosure relates to a method for improving dryness to down insulation. In some implementations of this embodiment, the method of the present technology allows to improve the overall longevity of down-filled-objects.

In one embodiment, the present disclosure relates to an article of manufacture such as, for example, a down-filled-object (e.g., jackets, duvets, pillows, sleeping bag, or the like) that has been treated by the method of the present technology.

In one embodiment, the present technology relates to a method of improving dryness to down insulation material. In some embodiments, the present technology also relates to a method that provides anti-microbial properties to the down insulation material.

In some embodiments, the method of the present technology comprises placing one or multiple layers of non-woven fabric adjacent or near the down material. The non-woven fabric is such that it extracts moisture out from the down material without condensation, based on the way specific types of fibers are deposited in a non-woven fabric structure and density of the non-woven fabric creating a low density non-woven structure. Further, the non-woven fabric may contain synthetic fibers with fine particles of natural elements such as ceramic, clay, etc., and/or with chemical anti-bacterial elements, for minimizing bacterial growth, odor, etc. Heat is retained in the garment, yet moisture is allowed to exit.

In some embodiments, the present technology enables home wash for apparel and similar products containing down feather material, because of the inherent quick drying properties provided by the low density structure. The technology may avoid the need to use a large quantity of water proof chemicals used in apparel and home fashion industry, credited to its down-proof properties. The technology helps increase the volume of down feather material after wash and dry cycles due to the rapid removal of moisture from down, allowing the hairs of the down feather material create its volume as much as possible.

In some embodiments, the present technology relates to a method of providing dryness to down insulation comprising: covering a down material with a non-woven material on at least one side of the down material; the non-woven material having sufficient density to create a low density non-woven fabric structure and being configured to extract moisture out of the down material without condensation based on the low density non-woven fabric structure; and covering the down material with the non-woven material.

In some instances, the non-woven material may further comprises fibers containing fine particles of natural elements (such as, but not limited to, ceramic, clay, or the like) and/or chemical anti-bacterial elements to control bacterial growth.

In one embodiment, the present technology relates to a method for improving dryness of down insulation, the method comprises covering the down material with a non-woven on a first-side of the down material as a first-layer, the non-woven material having sufficient density to create a low density non-woven fabric structure and being configured to extract moisture out of the down material adjacent the first-side without condensation based on the low density property from the non-woven material; and covering the down material with a non-woven material on a second-side of the down material as a second-layer, the non-woven synthetic insulation material being configured to extract moisture out of the down material adjacent the second-side without condensation also based on the low density property from the non-woven material.

In one embodiment, the present technology relates to a down-filled-object that has been treated by the method of the present technology. In some instances, the down-filled-object treated by the method of the present technology comprises a layer of down-material (which may be encased in a shell and/or lining fabric on the opposite side of the down-material) and a first layer of non-woven material located on a first-side of the down-material, wherein the down-material is covered with the non-woven synthetic insulation material on a first-side of the down-material, the non-woven material having sufficient density to create a low density non-woven fabric structure and being configured to extract moisture out of the down-material without condensation based on the low density non-woven fabric structure. The down-filled-object may further comprise a second layer of the non-woven material located on a second-side of the down-material; wherein the down-filled-object comprises a garment that is wearable in preferred embodiments or may comprise other objects such as apparel for example jackets, snowsuits, or home fashion products, or the like. Waterproofing of such objects is minimized or removed completely and longevity of down-filed items is increased as well as is the thermal efficiency during the lifetime of use (maintains resistance to transference of heat; cold spots are reinforced to provide improved warmth). The down-material may comprise natural-down-material or synthetic-thermal—insulation—material or other types of natural fibers such as cotton, wool, silk, etc., which may absorb moisture easily. The article described herein is able to be home-washed and is effectively windproof, water-resistant, and down-proof.

Referring now more specifically to the drawings by numerals of reference, FIGS. 1A, 1B and 1C show how a down-filled object 100 is constructed according to an embodiment of the present technology. In this embodiment, the down-filled object 100 comprises an encasing structure 110. In this embodiment, the encasing structure 110 comprises a first layer of non-woven material 112 and a second layer of non-woven material 114. In this embodiment, the first layer of non-woven material 112 and the second layer of non-woven material 114 are joined together along their periphery. In some instances, the first layer of non-woven material 112 and the second layer of non-woven material 114 are joined together by means such as, but not limited to, stitching or bonding. The joining of the first layer of non-woven material 112 and the second layer of non-woven material 114 creates a pocket 116 which is defined by the interior surface of the first and second layers 112, 114 of non-woven material. The pocket 116 is suitable to receive down-material 120. In the embodiments illustrated in FIG. 1, a first layer of shell material 130 is apposed onto the first layer of non-woven material 112 and a second layer of shell material 132 is apposed onto the second layer of the non-woven material 114. The first and second layers of shell material 130, 132 may be composed of shell fabric which may be any fabric in woven or knitted construction. In some instances, the first and second layers of shell material 130, 132 are apposed on the exterior surface of the first and second layers of non-woven materials 112, 114. In some instances, the interior surface of the first and second layers of non-woven materials 112, 114 form the wall of the pocket 116.

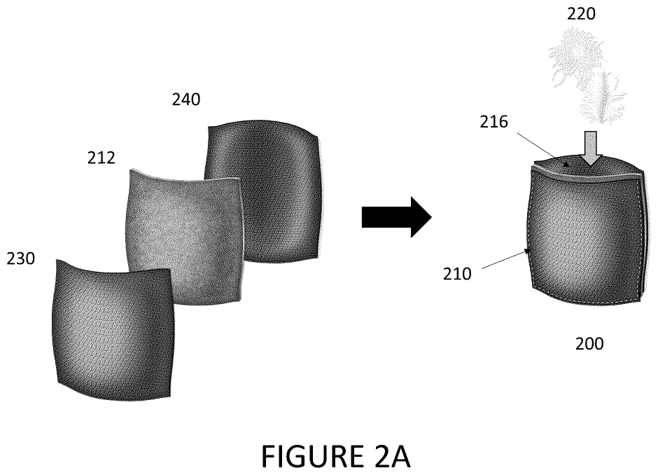

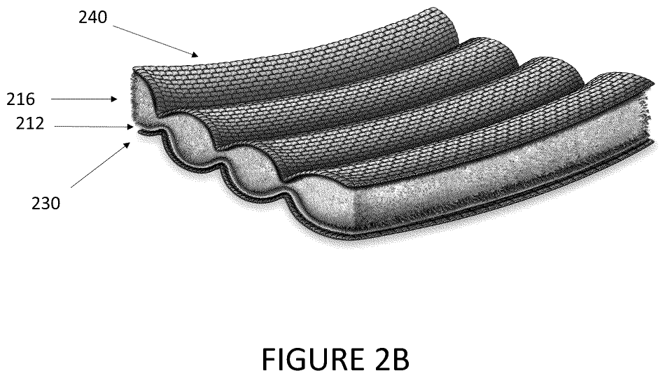

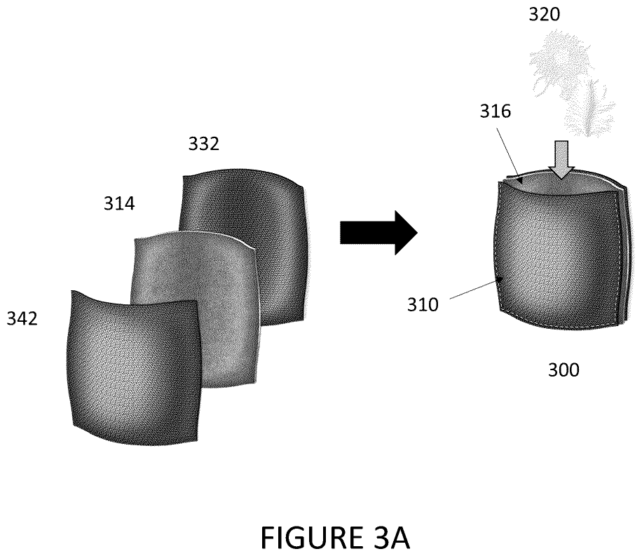

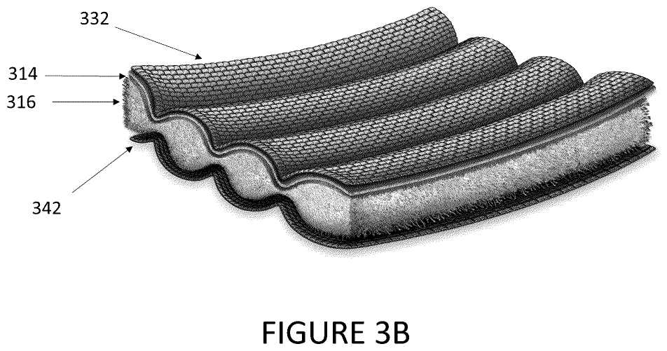

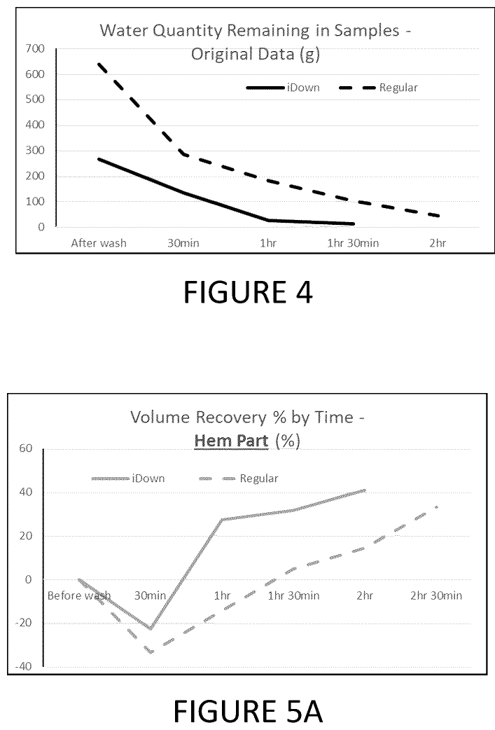

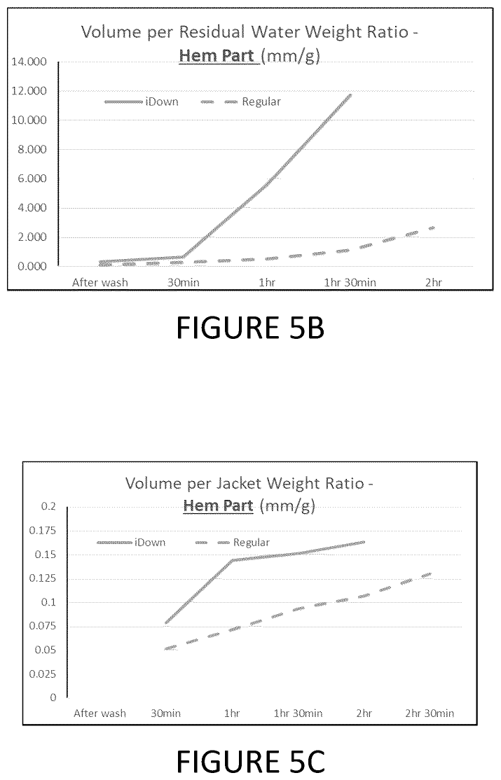

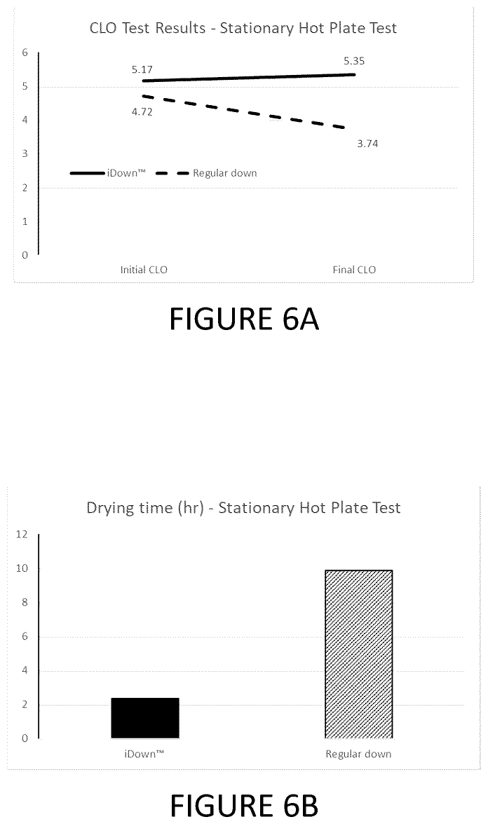

FIGS. 2A and 2B show a down-filled object 200 according to another embodiment of the present technology. In this embodiment, the down-material 220 is filled into a pocket 216 created by a layer of non-woven fabric 212 and a layer of woven or knitted fabric 240. In some instances, the layer of non-woven material 212 and the layer of woven or knitted fabric 240 are joined together by means such as, but not limited to, stitching or bonding. In some instances, the layer of woven or knitted fabric 240 is a shell layer. In some instances, the exterior side of the non-woven fabric 212 is covered by a layer of shell material 230. While one side of the layer of shell material 230 is facing the layer of non-woven material 212 with filling material in between when the pocket 216 is filled, the other a side of the layer of shell material 230 is facing the exterior environment.

FIGS. 3A and 3B shows a down-filled object 300 according to another embodiment of the present technology. In this embodiment, the down-material 320 is filled into a pocket 316 created by a layer of non-woven fabric 314 and a layer of woven or knitted fabric 342. In some instances, the layer of woven or knitted fabric 240 is a shell layer. In some instances, the layer of non-woven material 312 and the layer of woven or knitted fabric 342 are joined together by means such as, but not limited to, stitching or bonding. In some instances, the exterior side of the non-woven fabric 314 is covered by a layer of shell material 332. While one side of the layer of shell material 332 is facing the layer of non-woven material 314, the other a side of the layer of shell material 332 is facing the exterior environment.

In some embodiments, the down-material used for making the layer of down material may comprise natural-down-material (natural-down) or synthetic-down-material (synthetic-down) or natural fibers such as cotton, wool, silk, etc., or the like. In some embodiments, the down-material has a fill power rating of at least about 50 fill power, at least 100 fill power, at least 150 fill power, at least 200 fill power, at least 250 fill power, at least 300 fill power, at least 350 fill power, 400 fill power, at least 450 fill power, at least 500 fill power, at least 550 fill power, at least 600 fill power, at least 650 fill power, at least 700 fill power, at least 750 fill power, at least 800 fill power, at least 850 fill power, at least 900 fill power or at least 950 fill power. As used herein the expression “fill power rating” refers to the measure of the loft or fluffiness of a down product that is loosely related to the insulating value of the down. The higher the fill power, the more air a certain weight of the down can trap, and thus the more insulating ability the down will have.

In some embodiments, the non-woven material is a non-woven synthetic material. In some instances, the non-woven material is a non-woven insulation material. In further instances, the non-woven material is a synthetic insulation material. The non-woven synthetic insulation material is configured to extract moisture out of the down-material without condensation based on a built-in (inherent) low density non-woven fabric structure. In this way the down-material is suitably sheathed in a shell.

In some embodiments, the non-woven material has sufficient fiber density to create the desired low density non-woven fabric structure via reduction of air space within the material through the crossing of the fibers therein. Fibers used to create such characteristics of the non-woven fabric covered are of synthetic nature. In some instances, the fibers are substantially hydrophobic. Some of typical examples include, but are not limited to: polyester, polypropylene, acryl, nylon, or the like. However, some natural fibers such as cotton, wool, silk, or semi-natural fibers such as Sorona®, Tencel®, Rayon® may be used if chemical treatment is given to remove or minimize the hydrophilic nature of the fibers. In some embodiments, the non-woven fabric making of the non-woven material of the non-woven layer has a density ranging from about 0.05 lb/ft³ and about 100 lb/ft³.

In some embodiments, the non-woven material making of the non-woven layer has a weight ranging from about 1 (one) gram per square meter (gsm) to 200 gsm.

In some embodiments, the non-woven fabric is a fabric-like material made as sheet or web structures bonded together by entangling fiber or filaments mechanically, thermally or chemically. They are flat or tufted porous sheets that are made directly from separate fibers. They are not made by weaving or knitting and do not require converting the fibers to yarn. Typically, oil-based synthetic fiber materials are used in nonwoven fabrics. Some of the common examples are Polypropylene, Polyester, Nylon, Acryl etc. Recycled fibers may be used to create similar properties and the percentage of recycled fibers may vary based upon the purposes and properties for the specific use.

In some embodiments, the surface structure of the non-woven fabric comprises randomly deposited fibers. This surface structure creates maximum surface areas between fibers and contacting down feather material and minimizes the migration of down material, which leads to improved distribution of down material in the encased structure and improved down-leak-proof. As down-leak is frequent problem when using down-filled products, manufacturers have tried to use many methods to minimize it. One of the common methods is the waterproof treatment to close the gaps between the warp and weft yarns in the fabric. However, the holes created by sewing cannot be prevented by this method and most down-leak occurs in the stitched areas as the needle leaves larger hole than the diameter of sewing thread. A bonding method instead of stitching may be adopted to prevent down-leak. However, this method creates a large surface area where down material is not present or compressed in such way that it removes the air pockets of down material, hence creates large cold spots.

Fibers in the non-woven fabric structure according to the embodiments of the present technology are more easily repositioned than other types of fabrics. When needle holes are created, the fibers of the non-woven fabric of the present technology are easily repositioned by physical forces during cut-and-sew processes and/or handling of the finished goods, caused by the fibers in the non-woven fabric being able to reposition to conform to the shape of sewing thread. The non-woven fabric structure may include another sheet of non-woven fabric, commonly known as scrim, or woven or knitted fabric. The sheet of either another non-woven fabric, woven or knitted fabric may be laminated by glue during or after the non-woven making process. Either scrim side or opposite side may face the down material. Making encasing for accepting down material may be done through either stitching or bonding or combined of the two methods in the edges and/or along the periphery.

The down-filled object of the present technology may comprise other objects (non-garments) such as bedding home fashion products, e.g., pillows, comforters, etc., and the like (sleeping bags, or the like).

In some embodiments, the non-woven synthetic insulation material further comprises the fibers containing fine particles of natural elements; wherein the fine particles of natural elements may comprise ceramic, clay or the like and/or carbon nano-particles. The fine particles of such elements are included to inhibit bacterial growth and/or to minimize odor.

In some embodiments, the present technology provides for a method of improving dryness to down insulation. The method comprises forming an encasing structure which may be filled with down material. In some embodiments, the encasing structure is formed by joining together a first non-woven layer to a second layer of non-woven material by means such as, but not limited to bonding or stitching. In some embodiments, the method further comprises apposing a first layer of shell material onto the first layer of non-woven material and apposing a second layer of shell material onto the second layer of non-woven material. The first and second layers of shell material may be composed of shell fabric which may be any fabric in woven or knitted construction. In some instances, the first and second layers of shell material are apposed on the exterior surface of the first and second layers of non-woven materials. In some instances, the interior surface of the first and the second layers of the non-woven material forms the wall of the pocket.

In some embodiments, the present technology provides for a method of improving dryness to down insulation. The method comprises forming an encasing structure which may be filled with down material. In some embodiments, the encasing structure is formed by joining together a first non-woven layer to a layer of woven or knitted fabric and joining the layer of non-woven material and the layer of woven or knitted fabric together by means such as, but not limited to, stitching or bonding. In some instances, the exterior side of the non-woven fabric is covered by a layer of shell material. While one side of the layer of shell material is facing the layer of non-woven material, the other side of the layer of shell material is facing the exterior environment.

In some embodiments, the pocket created in the encasing is filled with down-material by techniques such as, but not limited to, by hand or mechanically by for example: a blower.

It should also be noted that the steps described in the method of use can be carried out in many different orders according to user preference.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

### EXAMPLES

The examples below are given so as to illustrate the practice of various embodiments of the present disclosure. They are not intended to limit or define the entire scope of this disclosure. It should be appreciated that the disclosure is not limited to the particular embodiments described and illustrated herein but includes all modifications and variations falling within the scope of the disclosure as defined in the appended embodiments.

### Example 1: Minimization of Water Retention in Treated Article

IDFL Wash Loft Test: One jacket comprising the encasing of the present technology (iDown®) was tested for water retention against a regular jacket (Regular), comprising the treatment of down-proof chemicals on shell fabrics, but not comprising the encasing of the present technology. The results are presented in FIG. 4. Both the iDown® jacket and Regular jackets are made by the same factory and same workers at the same time one after the other in order to keep the constructions and manufacturing techniques identical. Both the iDown® and Regular jackets are weighed and volumes are measured respectively before wash, then washed in a washing machine using a gentle cycle with warm water as in customary home wash method. The jackets are then weighed before being put into a dryer to calculate the weight of water retained in the jackets. During the drying process, the jackets are weighed and measured in volume in every 30 min interval in order to measure the quantity of water removal from the jackets as well as the volume increase of the jackets. Conclusions: The iDown® jacket comprising the encasing of the present technology contained 60% less water than the Regular jacket, due to the property of the low density non-woven fabric structure provided by encasing of the present technology. This may lead to the significant savings of time and electricity in washing down-filled articles at home while it is not necessary to dry-clean them to save the costs and contributing to health and environment.

### Example 2: Improve Volume Recovery in Treated Article

One jacket comprising the encasing of the present technology (iDown®) was tested for volume recovery against a regular jacket (Regular), comprising the treatment of down-proof chemicals on shell fabrics, but not comprising the encasing of the present technology. The results are presented in FIGS. 5A, 5B and 5C. Both the iDown® jacket and Regular jackets are made by the same factory and same workers at the same time one after the other in order to keep the constructions and manufacturing techniques identical. Both the iDown® and Regular jackets are weighed and volumes are measured respectively before wash, then washed in a washing machine using a gentle cycle with warm water as in customary home wash method. The jackets are then weighed before being put into a dryer to calculate the weight of water retained in the jackets. During the drying process, the jackets are weighed and measured in volume in every 30 min interval in order to measure the quantity of water removal from the jackets as well as the volume increase of the jackets. Conclusions: The iDown® jacket recovers its volume much faster than the Regular jacket and it creates larger volume in a given drying time. In addition, the volume created per a unit weight of down material of the iDown® jacket is larger because of increased rate of water moisture removal due to the properties of this encasing of the present technology, allowing the hairs of down material create its volume of air pockets larger than the Regular jacket.

### Example 3: Quick Drying and Volume Increase of Treated Article

IDFL Thermal Resistance of Batting Systems Using a Hot Plate ASTM D1518 Option 1: Still Air Condition (IDFL Report no. 18-275235). Both the iDown® jacket and the Regular jacket were measured in thermal efficiency (unit: CLO) before wash, then put in a washing process with warm water under gentle cycle, similar to customary home wash conditions. After wash, the back panels of the jackets were put on a heated plate of a test equipment in compliance with the ASTM D1518. Then, the test equipment measures the CLO values continually until the back panel is sufficiently dry to register a consistent level of CLO. The notable difference between the IDFL Wash Loft Test exemplified in the Examples 1 and 2 and this test is the fact that the former used a type of dryer used in home, allowing the articles to move within for faster exchange of heat from the dryer while the later uses the stationary hot plate to dry the contacting back panel (FIGS. 6A and 6B). Conclusions: The iDown® jacket recovered its intrinsic CLO fully while the Regular shows a significant decrease in the CLO value after having reached to the state of dryness. In terms of the drying time, the iDown® jacket dried 400% quicker than the Regular jacket, attributed to the ability to remove water and moisture due to the low density non-woven fabric structure covered in the encasing of the present technology. The higher rate of moisture removal of the iDown® jacket leads to larger volume created by a unit weight of down material at a given drying time.

Any feature of any embodiment discussed herein may be combined with any feature of any other embodiment discussed herein in some examples of implementation.

Certain additional elements that may be needed for operation of certain embodiments have not been described or illustrated as they are assumed to be within the purview of those skilled in the art. Moreover, certain embodiments may be free of, may lack and/or may function without any element that is not specifically disclosed herein.

Although various embodiments and examples have been presented, this was for the purpose of describing, but not limiting, the invention. Various modifications and enhancements will become apparent to those skilled in the art and are within the scope of the invention, which is defined by the appended claims.

1. A fortified plant-based formulation suitable for administration to a subject comprising:
a) at least one vitamin component;
b) at least one lipid component;
c) at least one protein component; and
d) at least one calcium-source component, wherein the at least one calcium-source component is an algae, and
wherein the at least one calcium-source component is present in the fortified plant-based formulation in an amount ranging from between about 0.5 to about 4 wt %.

2. The fortified plant-based formulation of claim 1, wherein the algae is red algae.

3. The fortified plant-based formulation of claim 2, wherein the red algae is of the class Rhodophyceae.

4. The fortified plant-based formulation of claim 3, wherein the Rhodophyceae is of the order Corallinale.

5. The fortified plant-based formulation of claim 4, wherein the Corallinale is a non-geniculate Coralline algae.

6. The fortified plant-based formulation of claim 5, wherein the non-geniculate Coralline algae is a rhodolith algae.

7. The fortified plant-based formulation of claim 6, wherein the rhodolith algae is selected from: Phymatolithon calcareum and Lithothamnium corralihoides.

8. The fortified plant-based formulation of claim 1, wherein the at least one calcium-source component further comprises magnesium.

9. The fortified plant-based formulation of claim 1, wherein the subject is a child.

10. The fortified plant-based formulation of claim 9, wherein the child is between 6 months old and 12 months old.

11. The fortified plant-based formulation of claim 9, wherein the child is between 12 months old and 24 months old.

12. The fortified plant-based formulation of claim 9, wherein the child is between 24 months old and older.

13. The fortified plant-based formulation of claim 1, wherein the vitamin component is selected from: biotin, riboflavin, thiamin, vitamin A, vitamin B-12, vitamin B-6, vitamin C, vitamin D, vitamin E, vitamin K, niacin, folate, and pantothenate.

14. The fortified plant-based formulation of claim 1, wherein the vitamin component is present in the fortified plant-based formulation in an amount ranging between about 0.02 and about 0.1 wt %.

15. The fortified plant-based formulation of claim 1, wherein the lipid component is selected from fats, oils, glycerides, phospholipids, and free fatty acids.

16. The fortified plant-based formulation of claim 1, wherein the lipid component is present in the fortified plant-based formulation in an amount ranging between about 5 and about 35 wt %.

17. The fortified plant-based formulation of claim 1, wherein the protein component is selected from a non-animal source.

18. The fortified plant-based formulation of claim 1, wherein the protein component is present in the fortified plant-based formulation in an amount ranging between about 10 and about 50 wt %.

19. The fortified plant-based formulation of claim 1, wherein the formulation further comprises a carbohydrate component.

20.-29. (canceled)

30. A method for providing a nutritional supplement to a subject, the method comprising feeding the fortified plant-based formulation as defined in claim 1 to a subject.
